(19) United States
(12) Patent Application Publication
(10) Pub. No.: US 2026/0216674 A1
(43) Pub. Date: Jul. 30, 2026

(54) TAPERED VERTICAL BLENDER WITH REMOVABLE LID AND ANTI-TORQUE MOUNT

(71) Applicant: Ag Growth International Inc., Winnipeg (CA)

(72) Inventors: David GUTIERREZ, Plainfield, IL (US); Eric Jason GARD, Casey, IL (US); Jared Martin SMITH, Lisle, IL (US); Robert FITZPATRICK, New Lennox, IL (US); Ralph Moussa EL RASSI, Bologna (IT)

(21) Appl. No.: 19/041,680

(22) Filed: Jan. 30, 2025

(51) Int. Cl. B01F 27/1143; B01F 35/11; B01F 35/45; B01F 35/53; B01F 35/71

(52) U.S. Cl. CPC B01F 27/1143; B01F 35/11; B01F 35/45; B01F 35/53; B01F 35/712

(57) ABSTRACT

A tapered vertical blender may include a container with a top portion, a lid that may be removably coupled to the top portion of the container, and an auger assembly that may be coupled to the lid. The auger assembly may feature an auger screw that extends through the lid and into the container. This design may simplify the process of accessing the interior of the container and the auger screw, eliminating the need for heavy lifting equipment to move the entire blender. The removable lid feature provides a practical solution to the challenges faced in commercial and industrial blending operations, particularly when dealing with large-scale equipment.

### FIELD OF TECHNOLGOY

The present disclosure relates generally to tapered vertical blenders, and more specifically to tapered vertical blender with a removable lid and an anti-torque mount.

### BACKGROUND

In the field of material processing, vertical blenders are equipment that may be used to mix and blend various media, such as chemicals, food products, and pharmaceuticals. These blenders may have of a container that is often tapered from top to bottom and may include an internal auger or screw for the purpose of mixing. These containers typically have a bottom opening through which a motor is coupled to the internal auger or screw. Vertical blenders may also include features such as media inlets and outlets, and in some cases, drip bars for adding a coating to media received in the container.

### SUMMARY

The described implementations relate to improved tapered vertical blenders having a removable lid. In some examples, a vertical blender may feature a container with a top opening and a lid that is removably coupled to the container. This configuration may allow for direct access to the interior of the container and the auger assembly without the need to reposition the entire blender, thereby simplifying maintenance and repair processes. The removably coupled lid may provide a convenient entry point for servicing the internal components, significantly reducing downtime and eliminating the requirement for heavy lifting equipment.

Additionally, some implementations may include an anti-torque mount for a top-mounted auger-assembly. The anti-torque mount is coupled to the lid to enhance the stability of the blender during operation. The anti-torque mount may comprise a mounting plate and a series of struts that are strategically offset to resist the reaction torque generated by the auger assembly. This offset configuration may provide a mechanical advantage that effectively counters the rotational forces, ensuring that the auger assembly, the lid, and the blender as a whole remains stable and secure. The offset struts may be designed to distribute the torque load evenly, preventing any unwanted movement and contributing to the overall efficiency and safety of the blending process.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 shows a perspective view of a tapered vertical blender having a removable lid and anti-torque mount in accordance with various aspects of the present disclosure;

FIG. 2 shows a front view of the tapered vertical blender of FIG. 1 in accordance with various aspects of the present disclosure;

FIG. 3 shows a top view of the tapered vertical blender of FIG. 1 in accordance with various aspects of the present disclosure; and

FIG. 4 shows a detail view of the tapered vertical blender of FIG. 1 with the container hidden to expose an auger screw in accordance with various aspects of the present disclosure.

### DETAILED DESCRIPTION

The described implementations relate to improved tapered vertical blenders with a removable lid and a top-mounted auger assembly. Some aspects may include an anti-torque mount upon which the auger assembly is coupled. In some examples, the maintenance and repair of vertical blenders may pose significant logistical challenges. The conventional design may require the entire blender to be moved or tilted to access the internal components, which may be impractical for large and heavy units. This process may often necessitate the use of specialized heavy lifting equipment, leading to increased downtime and higher operational costs. Furthermore, the reaction torque generated by the auger’s drive mechanism may compromise the stability of the auger assembly, the removable lid, and/or the blender as a whole.

According to some implementations, a vertical blender may include a container with a top opening that is covered by a lid. This lid may be removably coupled to the container, which allows for easy access to an interior of the container and the auger assembly. The auger assembly may be attached to the lid and includes an auger screw that extends through the lid into the container. This setup may allow for the removal of the auger screw by detaching the lid, facilitating maintenance without the need to reposition the entirety of the blender.

The auger assembly may be fixedly coupled to an anti-torque mount to resist reaction torque during operation. The anti-torque mount may include a mounting plate and a number of struts. These struts may extend from the mounting plate to the edge of the lid and are offset from the center of the mounting plate. This offset may provide a mechanical advantage that helps resist the reaction torque generated by the auger assembly.

In some aspects, the lid may include a spray assembly, which consists of several spray nozzles that extend through the lid. These nozzles may be designed to release a fluid into the container. The spray assembly may include a fluid supply line, a master valve for closing the fluid supply line, and a spray line that delivers fluid from the master valve to the spray nozzles. The nozzles may be positioned in an array around the lid. A blow-off valve may be coupled to the spray assembly downstream of the master valve, allowing the spray line and nozzles to be cleared between batches.

The container may be suspended from a frame, which includes several legs and cross beams. The container may feature a flange at the top edge, which is fixed atop the legs of the frame. In some aspects, the lid is removably coupled to the flange. The container may have a top portion that may be cylindrical, with a tapered portion extending downwardly from the cylindrical top portion. The diameter of the tapered portion may decrease along the vertical axis from the top to the bottom of the container.

The container may also include a media inlet and a media outlet. The media inlet may be positioned on the side of the container or on the lid, depending on the design. It may be designed for communicating batches of media to be blended into the container. The media outlet may be positioned at the bottom of the container, which may allow a gravity flow to assist with removal of the blended media from the blender.

In some designs, the vertical blender may include a forced air system to assist with the drying process when a coating is applied to media in the blender. This system may comprise an air supply, such as a blower, an air inlet, and an air exhaust. A heat exchanger may also be included to pre-heat the air introduced into the container through the air inlet. Depending on the design, the air inlet and the air exhaust may be positioned on a side of the container and/or on the lid.

The lid may be constructed from a single panel or multiple panels that are joined together (e.g., by welding) to form a unitary lid body. In some aspects, the lid may include a flange or a lip through which the lid is removably coupled to the container. Depending on the design and the features incorporated in the blende, the lid may include one or more openings (e.g., an air exhaust, a media inlet, spray nozzles, etc.) for communicating fluids or media into or out of the container.

Mounting brackets, which may include a vertical flange and an opening in the vertical flange, may be affixed to the lid at the edge. The openings in the vertical flanges may serve as attachment points for lifting the lid or the lid and auger assembly off of the container. Thus, the lifting mounts may facilitate the handling and removal of the lid when accessing the interior of the container or the auger assembly. In some aspects, the mounting brackets may be aligned with and/or directly coupled to the legs such that force from the anti-torque mount is transmitted to the legs and/or frame.

Aspects hereof may be described using directional terminology. For example, the Cartesian coordinate system may be used to describe positions and movement or rotation of the features described herein. Accordingly, some aspects may be described with reference to three mutually perpendicular axes. The axes may be referred to herein as lateral, longitudinal, and vertical, and may be indicated by reference characters X, Y, and Z, respectively, in the accompanying figures.

For example, the terms “vertical” and “vertically” as used herein refer to a direction perpendicular to each of the lateral and longitudinal axes. Additionally, relative location terminology will be utilized herein. For example, the term “proximate” is intended to mean on, about, near, by, next to, at, and the like. Therefore, when a feature is proximate another feature, it is close in proximity but not necessarily exactly at the described location, in some aspects. Additionally, the term “distal” refers to a portion of a feature herein that is positioned away from a midpoint of the feature.

Aspects of the subject matter described in this disclosure can be implemented to realize one or more of the following potential advantages. The described techniques may be implemented to support easier maintenance and repair operations, as the lid and auger assembly may be detached without the need to move the entire blender. The offset struts of the anti-torque mount may provide stability and durability to the structure, potentially reducing wear and tear on the components. The spray assembly may offer precise control over the application of fluids within the container, which may improve the consistency and quality of the blending process. The inclusion of a forced air system may enhance the efficiency of drying processes, potentially leading to faster production times. The design may allow for flexible placement of media inlets and outlets, which may accommodate different operational layouts and processes. The removability of the lid may facilitate the addition of components or modifications to the system without significant downtime. The versatility in lid construction may allow for customization according to specific needs, potentially making the blender suitable for a wide range of industrial applications.

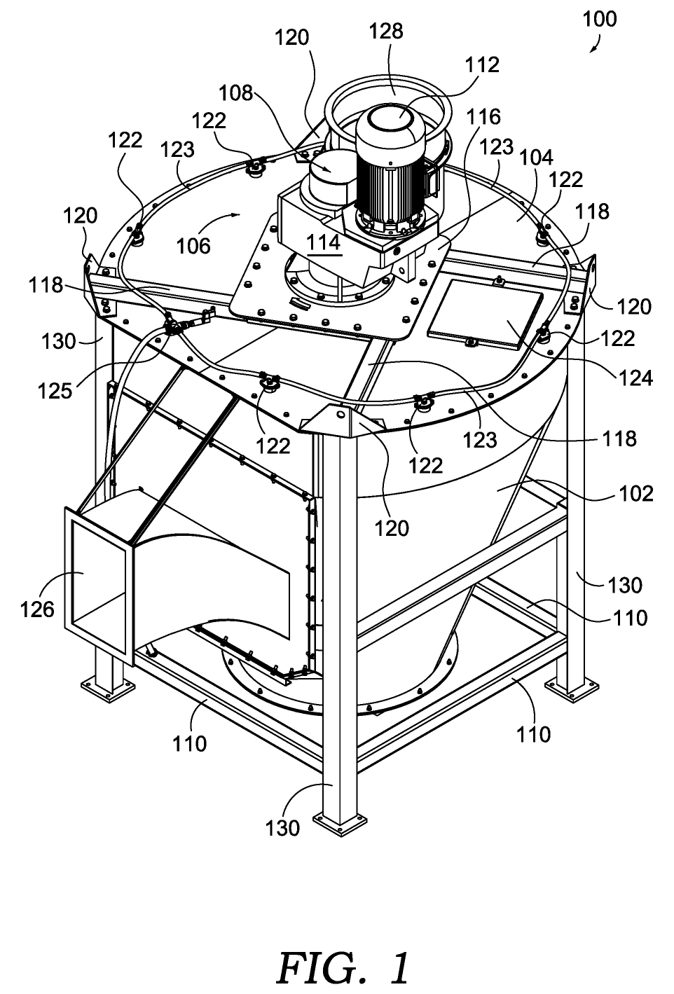

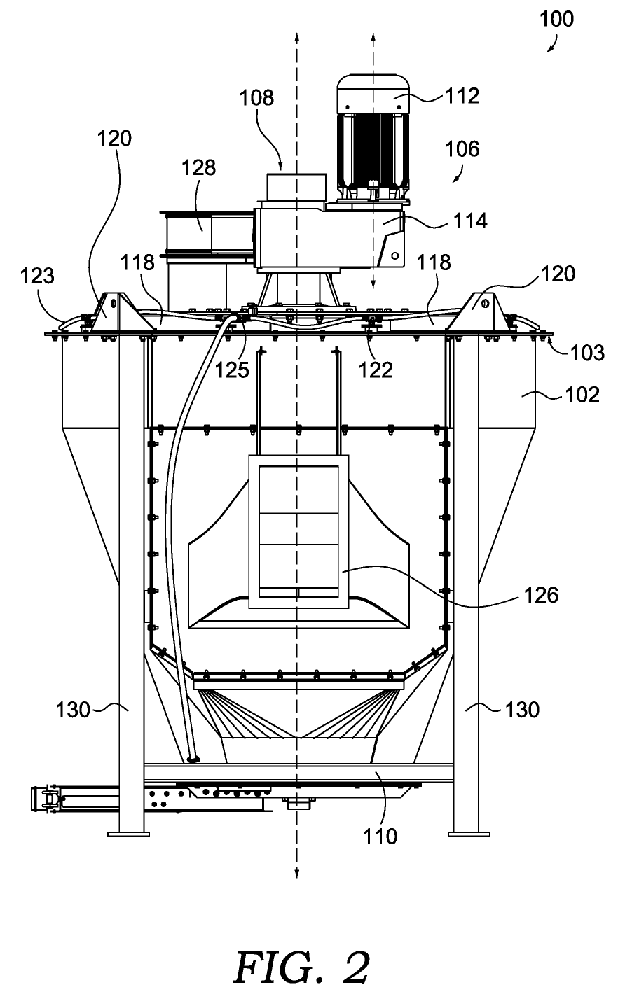

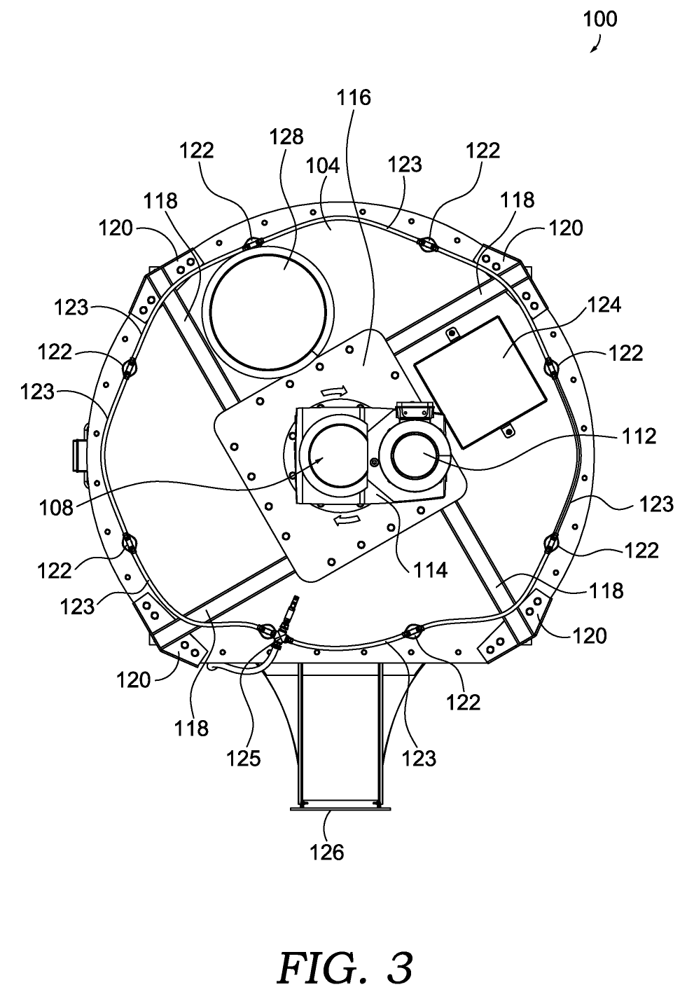

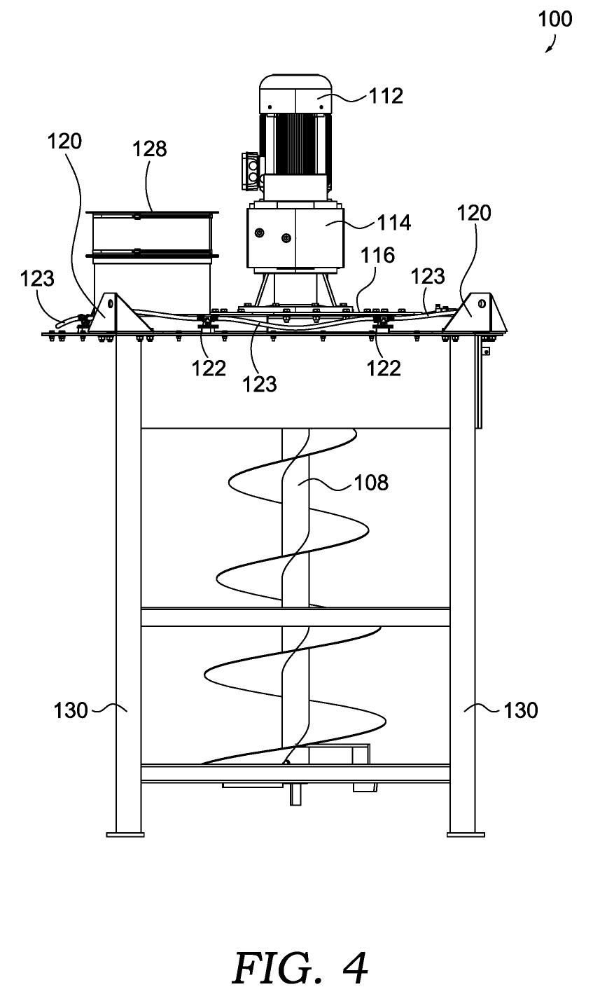

Aspects of the disclosure are initially described in the context of tapered vertical blender illustrated in FIGS. 1-4. FIG. 1 shows a perspective view of a tapered vertical blender having a removably coupled lid and an anti-torque mount FIG. 2 shows a front view of the tapered vertical blender of FIG. 1. FIG. 3 shows a side view of the tapered vertical blender of FIG. 1. FIG. 4 shows a detail view of the tapered vertical blender of FIG. 1 with the container hidden to show the auger screw.

As seen in FIG. 1 a tapered vertical blender 100 includes a container 102 that is designed to hold and blend various media (e.g., chemicals, food products, pharmaceuticals, fertilizers, etc.). In some aspects, two or more types of media is blended together in the container 102. In other aspects, a coating may be applied to the media in the container 102.

The container 102 may have a shape that facilitates the blending process. The container 102 may be constructed from materials suitable for holding and mixing various media. For example, the container 102 may be constructed from stainless steel or other durable materials. Thus, the container 102 may be constructed from materials that are resistant to abrasion and corrosion.

The container 102 may be shaped to facilitate the blending process, with a design that may promote the movement of media within it. The illustrated container 102 includes a media outlet and a tapered portion that extends up from the media outlet to a top portion. In aspects, the top portion may be cylindrical. The top portion may include a top edge and a flange 103 may extend radially outward from the top edge. The flange 103 may provide a surface for a lid 104 to rest upon and may be designed to ensure a secure fit between the lid 104 and the container 102. Thus the container 102 may be designed to work in conjunction with the lid 104 to enclose the media to be blended.

The lid 104 may be removably coupled to the container 102. The lid 104 may provide access to the interior of the container 102 when removed. The lid 104 may be designed to form a seal with the container 102 when in place. The lid 104 may be secured to the container 102 using fastening mechanisms (e.g., bolts, rivots, clamps, or other removable fasteners) that allow for easy removal and attachment. The lid 104 may be configured to prevent spillage or contamination of the contents of the container 102. In some aspects, the lid 104 may include handles or other lifting points to aid in its removal from the container 102. Although illustrated as a flat panel, the lid 104 may comprise other shapes or geometries.

An auger assembly 106 may be coupled to the lid 104. The auger assembly 106 may serve to mix the media within the container 102. The auger assembly 106 may be designed to be easily detachable from the lid 104 for maintenance or cleaning. The auger assembly 106 may be positioned in such a way that it is aligned with the center of the lid 104 for operation.

The auger assembly 106 includes an auger screw 108. The auger screw 108 may extend through the lid 104 and into the container 102. The auger screw 108 may be the primary component responsible for blending the media. The auger screw 108 may be constructed from durable materials to withstand the stresses of blending. The auger screw 108 may be centrally located within the container 102 to ensure even mixing of the media. The auger screw 108 may have a helical shape to facilitate the lifting, agitating, and folding of media. For example, the helical shape may facilitate movement of the media from the bottom to the top of the container 102 when rotated. In aspects, the auger screw 108 may interact with the container 102 (or components therein, such as a shroud) to ensure even blending of materials.

The auger assembly also may include a motor 112 coupled to the auger screw 108 to perform the blending action. The motor 112 may be part of the drive mechanism for the auger assembly 106. The motor 112 may provide the necessary power to rotate the auger screw 108. The motor 112 may be electrically powered and connected to a power source. The motor 112 may be mounted in a location that allows for efficient transfer of power to the auger assembly 106.

In some aspects, the motor 112 may be coupled to the auger screw 108 by a gear box 114. The gear box 114 may be responsible for transferring the motor’s power to the auger screw 108. The gear box 114 may contain gears that reduce the speed of the motor 112 to a suitable level for blending. The gear box 114 may be securely attached to ensure the transfer of power is consistent and reliable.

The illustrated lid 104 includes an anti-torque mount. The anti-torque mount includes a mounting plate 116 and one or more struts 118. In the illustrated aspect, the auger assembly 106 is coupled to the mounting plate 116. The mounting plate 116 may serve as the foundation for the anti-torque system. The mounting plate 116 may be designed to distribute the forces generated by the auger assembly 106. The mounting plate 116 may be connected to other components that help resist the torque produced during operation of the auger screw 108.

The struts 118 may extend from the mounting plate 116 to the perimeter of the lid 104. The struts 118 may provide structural support to the anti-torque mount. The struts 118 may be arranged to counteract the rotational forces exerted by the auger assembly 106. The struts 118 may be attached to the lid 104 at points that help distribute the reaction forces effectively. As best seen in FIG. 3, the struts 118 may be offset from the center of the mounting plate 116 to gain a mechanical advantage against the reaction torque generated by the auger screw 108.

Mounting brackets 120 may be affixed to the lid 104. The mounting brackets 120 may serve as connection points for the struts 118. The mounting brackets 120 may be strategically placed around the perimeter of the lid 104 to provide optimal support. The mounting brackets 120 may each include a lifting lug that serves as a connection point for equipment that lifts the lid 104 off of the container 102. The lifting lugs may comprise pad eye, a hoist eye, an eye bolt, a D-ring, or other like anchor or attachment points.

The container 102 may be affixed to a frame 110. The frame 110 may support the container 102 and the entire structure of the tapered vertical blender 100 above a surface. The frame 110 may be designed to provide stability to the tapered vertical blender 100. The frame 110 may be constructed from materials (e.g., steel or other durable materials) that can support the weight of the container 102 and its contents. The frame 110 may be configured to allow for the container 102 to be elevated above the ground.

The frame 110 may include legs 130, cross-beams, and braces. The legs 130 may provide the necessary height for the container 102 to be positioned above a surface and facilitate unloading of the container 102 through the media outlet at the bottom of the container 102. In some aspects, the legs 130 may be adjustable to accommodate different installation surfaces and to ensure the tapered vertical blender 100 is level. In some aspects, the legs 130 may be set upon piers.

The legs 130 may be joined to the container 102 at the flange 103, in some aspects. Thus, the container 102 may be suspended from the legs 130.

In some aspects, the legs 130 are aligned with the mounting brackets 120. In these aspects, the mounting brackets 120 may be fastened to the legs 130. This may allow the force transferred from the anti-torque mount to be directly transferred to the frame 110 and/or the legs 130.

A spray assembly may be coupled to the lid 104, in some aspects. For example, a coating material may be applied to a media in the container 102 during a blending process. In another example, the spray assembly may be configured to clean an interior of the container 102 in between blending batches.

The spray assembly may include one or more spray nozzles 122, one or more spray lines 123 in communication with the one or more spray nozzles 122, and a supply line in communication with the one or more spray lines 123. A valve 125 may be positioned between the supply line and the one or more spray lines 123 to control delivery of a fluid into the container 102. The valve 125 may be operated to start or stop the flow of fluid as needed.

The spray nozzles 122 may extend through the lid 104. The spray nozzles 122 may be used to introduce fluids into the container 102. The spray nozzles 122 may be arranged in a pattern that ensures even distribution of the fluid within the container 102. For example, the spray nozzles 122 may be arranged around a periphery of the lid 104 in an array. The spray nozzles 122 may be connected to a fluid delivery system that controls the flow and pressure of the fluid. The spray nozzles 122 may be designed to create a specific spray pattern within the container 102.

Media may be received in the container 102 through a media inlet 124. The media inlet 124 may be in communication with the interior of the container 102. The media inlet 124 may allow for the introduction of media to be blended into the container 102. The media inlet 124 may be positioned to facilitate the loading of media without the need for additional equipment. In other aspects, a conveyor may deliver a batch of media to the media inlet 124. The media inlet 124 may be designed to prevent spillage and ensure that the media is directed into the container 102 efficiently. In some implementations, the media inlet 124 may include a valve or gate to control the flow of media into the container 102.

Media may be removed from the container 102 through the media outlet. Gravity may assist the flow of media out of the container 102. In some aspects, a conveyor or an auger may receive media communicated out of the media outlet for transport to another location. The media outlet may include a valve or gate to control the flow of media out of the container 102.

The tapered vertical blender 100 may optionally be configured to couple with a forced-air system. In these aspects, the container 102 may include an air inlet 126 and an air exhaust 128. The forced-air system may assist with a drying process. For example, when a coating is applied to a media in the container 102, the forced-air system may accelerate setting of the coating on the media.

The air inlet 126 may allow for the introduction of air into the container 102. The air inlet 126 may be connected to a blower or other air-moving device. The air inlet 126 may be used to control the temperature and humidity within the container 102 during the blending process.

The air exhaust 128 may be in communication with the interior of the container 102. The air exhaust 128 may allow for the removal of air from the container 102. The air exhaust 128 may be connected to a duct system that directs the exhaust air away from the blending area. The air exhaust 128 may be equipped with filters or other devices to clean the air before it is released into the environment.

### Europe or China filing anticipated? Add clauses here.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A tapered vertical blender, comprising:
a container having a top portion;
a lid removably coupled to the top portion of the container; and
an auger assembly coupled to the lid, the auger assembly having an auger screw extending through the lid and into the container.

2. The tapered vertical blender of claim 1 further comprising a flange extending radially out from a top edge of the container, wherein the lid is removably fastened to the flange.

3. The tapered vertical blender of claim 2 further comprising a frame, wherein the container is suspended from the frame, the frame including a plurality of legs and cross beams, and the flange of the container is fixed atop the plurality of legs.

4. The tapered vertical blender of claim 1 further comprising a media inlet positioned on the lid, the media inlet configured for communicating a batch of media to be blended into the container.

5. The tapered vertical blender of claim 1 further comprising the auger assembly fixedly coupled to an anti-torque mount, wherein the anti-torque mount is coupled to the lid and comprises a mounting plate and a plurality of struts extending from the mounting plate to a perimeter of the lid.

6. The tapered vertical blender of claim 1 further comprising a spray assembly coupled to the lid, wherein the spray assembly comprises a supply line, a valve coupled to the supply line, a spray line coupled to the valve, and a plurality of spray nozzles coupled to the spray line, each spray nozzle extending through the lid and configured to communicate a fluid into the container.

7. The tapered vertical blender of claim 6, wherein the spary assembly includes a blow off valve configured to clear blockages in the spray line or the spray nozzles.

8. The tapered vertical blender of claim 1, wherein the container includes an air inlet and the lid includes an air exhuast, the air exhaust and the air inlet facilitating airflow through the container.

9. The tapered vertical blender of claim 1, wherein the lid comprises a mounting bracket, the mounting bracket providing an attachment point for auxiliary equipment.

10. The tapered vertical blender of claim 1, wherein the auger screw is driven by a motor through a gear box.

11. The tapered vertical blender of claim 1, wherein the lid comprises a unitary panel.

12. The tapered vertical blender of claim 1, wherein the lid is planar.

13. The tapered vertical blender of claim 1, wherein the lid is removably fastened to the container.

14. A lid and auger assembly for a tapered vertical blender, the lid and auger assembly comprising:
a panel;
a plurality of mounting brackets extending from the panel;
a mounting plate positioned over a center of the panel;
a plurality of struts extending between the mounting brackets and the mounting plate, the struts joined to the mounting plate at positions offset from a center of the mounting plate;
the auger assembly coupled to the mounting plate, the auger assembly comprising an auger screw extending through the center of the panel, an auger housing coupled to the auger screw and configured to permit rotation of the auger screw relative to the auger housing, a gear box coupled to the auger housing, and a motor coupled to the gear box, the gear box having at least one gear configured to communicate rotational energy from the motor to the auger screw.

15. The lid and auger assembly of claim 14, wherein mounting brackets are integral to the panel.

16. The lid and auger assembly of claim 14, wherein mounting brackets are joined to the panel.

17. The lid and auger assembly of claim 14, wherein mounting brackets include attachment points adapted for equipment to lift the lid and auger assembly.

18. The lid and auger assembly of claim 14, wherein struts are offset from the center of the mounting plate in a direction providing a mechanical advantage in resisting reaction torque from operation of the auger screw.

19. The lid and auger assembly of claim 14, wherein the panel includes a media inlet configured for communicating media through the lid.

20. The lid and auger assembly of claim 14, wherein the panel include an air exhaust configured for communicating air through the lid.
